(19) United States
(12) Patent Application Publication
(10) Pub. No.: US 2002/0073723 A1
(43) Pub. Date: Jun. 20, 2002

(54) Air-conditioning system for a vehicle

(76) Inventor: Martin Hoos, Will. -Steina (DE)

Correspondence Address: DECKER, JONES, MCMACKIN, MCCLANE, HALL &, BATES, P.C., BURNETT PLAZA, 801 CHERRY STREET, SUITE 2000, FORT WORTH, TX, 76102-6836, US

(21) Appl. No.: 09/840,504

(22) Filed: Apr. 23, 2001

(30) Foreign Application Priority Data
Dec. 15, 2000 (DE) 10062686.6 DD

(51) Int. Cl. B60H 1/32

(52) U.S. Cl. 62/244

(57) ABSTRACT

An air-conditioning system (16) for installation in a roof opening (14) of a vehicle, in particular a bus, the roof of which has been reinforced by means of a framework, with the partial framework (18) corresponding to roof opening (14) forming a base element (20) of air-conditioning system (16), to which components (26, 28, 30) of air-conditioning system (16) are attached.

### BACKGROUND OF THE INVENTION

1. Field of the Invention

The invention concerns an air-conditioning system for installation in a roof opening of a frame-reinforced vehicle roof, in particular the roof of a bus.

2. Description of the Prior Art

This type of air-conditioning system is known, e.g., from DE-OS 27 57 415. This know air-conditioning system extends between the two side walls of the bus. It features a casing that essentially extends across the entire width of the bus and is supported on the roof of the bus by means of two carrier rails. The two carrier rails are attached in the vicinity of the sidewalls of the bus and they are attached to the part of the roof area that can support it without excessive mechanical stresses and deformations, with the attachment being implemented by means of threaded or welded connections. Above the vehicle roof, this air-conditioning system features minimal dimensions that cannot be reduced. These dimensions are required due to the mentioned carrier rails.

A device for air-conditioning of the passenger compartment of a bus with a casing for roof mounting is also known, e.g., from DE 33 17 510 A1.

DE 34 06 249 C2 discloses an air-conditioning system for motor vehicles, in particular for busses, that are designed for installation in a roof opening of a vehicle. This air-conditioning system features a self-supporting casing, which is mechanically reinforced by separating walls forming sidewalls.

A device for ventilation and air-conditioning of driver cabins, driver seats, or the like for towing machines, tractors, construction machines, operating machinery or the like is described in De 35 115 853 A1. There, a base plate extends between traverse elements and longitudinal rails parallel to the roof of the device at a defined distance from the roof.

DE 44 05 774 C2 describes an air-conditioning system, in particular for busses, with a casing that can be mounted on the roof of the vehicle. There, the vehicle roof is reinforced by a support rail in the area of the lateral roof opening for the purpose of creating a stable connection between a duct cover and the roof of the vehicle. This support rail, in addition to the lateral roof opening, contributes to reinforcing the roof panel. Here, several auxiliary rails are used for better mechanical strength.

### SUMMARY OF THE INVENTION

The present invention is based on the task of developing an air-conditioning system of the aforementioned type that features optimal rigidity and dimensional stability with reduced overall weight.

According to the invention, this task is solved by the characteristic in that the partial framework forming the roof opening of the vehicle constitutes a base element of the air-conditioning system, to which components of the air-conditioning system are attached.

The original framework is omitted in the area of the roof where the air-conditioning system is to be installed, i.e., in the roof opening for the air-conditioning system. The corresponding vehicle is designed with a suitable roof opening in the area, in which the roof-mounted air-conditioning system is to be installed. The partial framework that is to be used to reinforce the roof opening is used as the base element of the air-conditioning system. The various components of the air-conditioning system are attached to the base element, formed by the partial framework of the roof opening, i.e., mounted on or to said partial framework. The partial framework forming the base element of the air-conditioning system is used to reinforce the air-conditioning system, while simultaneously reducing its weight in an advantageous way. In addition, advantageously, this partial rib element can serve as a mechanically stable transport rack.

It is preferred for the air-conditioning system according to the invention if the base element formed by the partial framework features a circumferential sealing flange, in order to allow the air-conditioning system according to the invention to be attached at a later point in time in a positive manner, i.e., when the air-conditioning system is installed in the accordingly prepared vehicle roof. This can be done by means of screws or welding.

The base element of the air-conditioning system according to the invention formed by the partial framework is expediently connected to a covering hood that covers the various components of the air-conditioning system. The covering hood may feature inlet openings for fresh air on its topside and/or at its two opposing longitudinal sidewalls. Fresh air can be optionally introduced into the air-conditioning system according to the invention from the top or from the side.

The condenser of the air-conditioning system according to the invention may be positioned in a central area of the air-conditioning system. The condenser may also be positioned in the travel direction in front of or behind the evaporator.

It has been found to be practical, if the evaporator is positioned on a bottom tray. The bottom tray is advantageously recessed into the base element featuring the partial framework. This generates the advantage that the optical overall height, i.e., the visible overall height of the air-conditioning system above the vehicle roof is minimal-viewed from the side. The bottom tray of the evaporator can be recessed into the roof arch. The original height of the roof arch can be recessed into the roof arch. The original height of the roof arch can be used as suction air intake. For this purpose, a bottom center suction intake opening for return air can be part of the base element that is formed by the partial framework. The return air can be taken from the aisle area of the bus in order to prevent reduced space in the luggage area.

Other details, characteristics and advantages result from the following description of an embodiment of the air-conditioning system according to the invention shown in the drawing or from essential parts of this system.

### BRIEF DESCRIPTION OF THE DRAWINGS

FIG. 1 is a perspective view of a surface section of a vehicle roof, in particular of a bus, with the roof being configured with a roof opening for an air-conditioning system.

FIG. 2 is a three-dimensional exploded view of the surface section of the vehicle roof according to FIG. 1 in combination with a partial framework of the roof opening.

FIG. 3 is a three-dimensional view of the surface section of the vehicle roof shown in FIGS. 1 and 2 with the air-conditioning system, of which only a few components and section of the covering hood are shown, postioned in the roof opening.

FIG. 4 is a cross-section through the air-conditioning system and the pertinent roof section of the vehicle, with the left partial section of the air-conditioning system not shown.

FIG. 5 is an enlarged view of detail shown in the circle V in FIG. 4.

### DESCRIPTION OF THE PREFERRED EMBODIMENTS

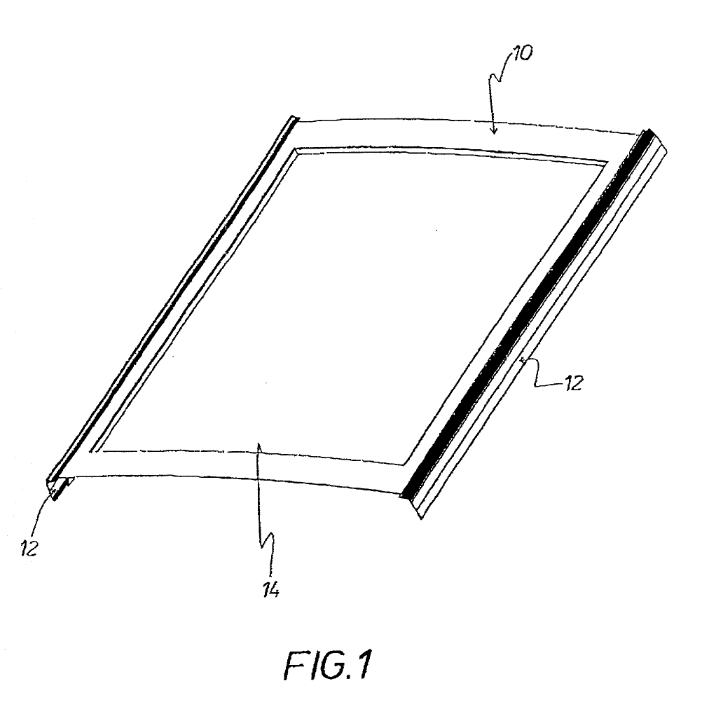

FIG. 1 shows a surface section 10 of a vehicle roof, in particular the roof of a bus, featuring two lateral longitudinal devices 12, by means of which the corresponding surface section 10 of the roof is connected to the (not shown) lateral walls of the vehicle. The vehicle roof, or corresponding surface section 10 features a framework, by means of which the vehicle roof is made more rigid.

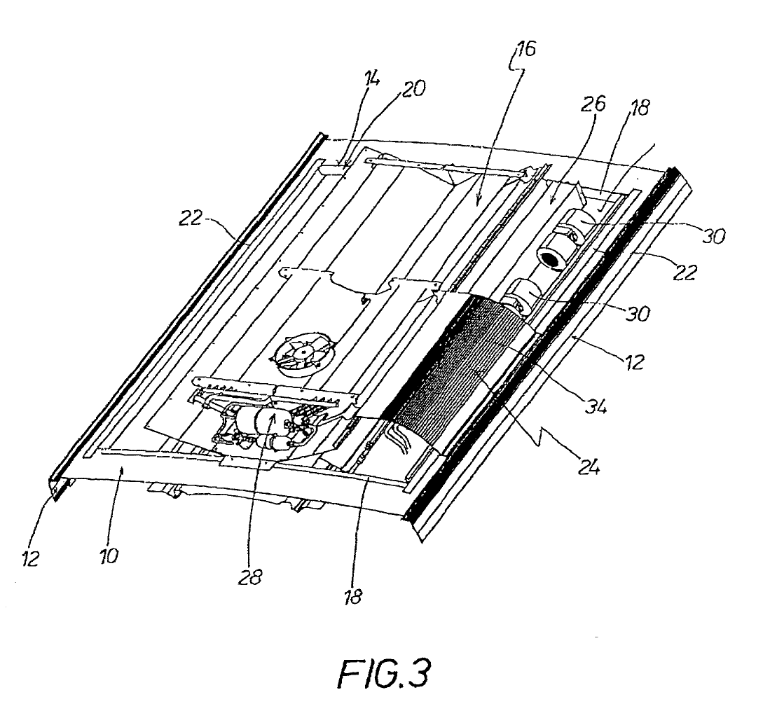

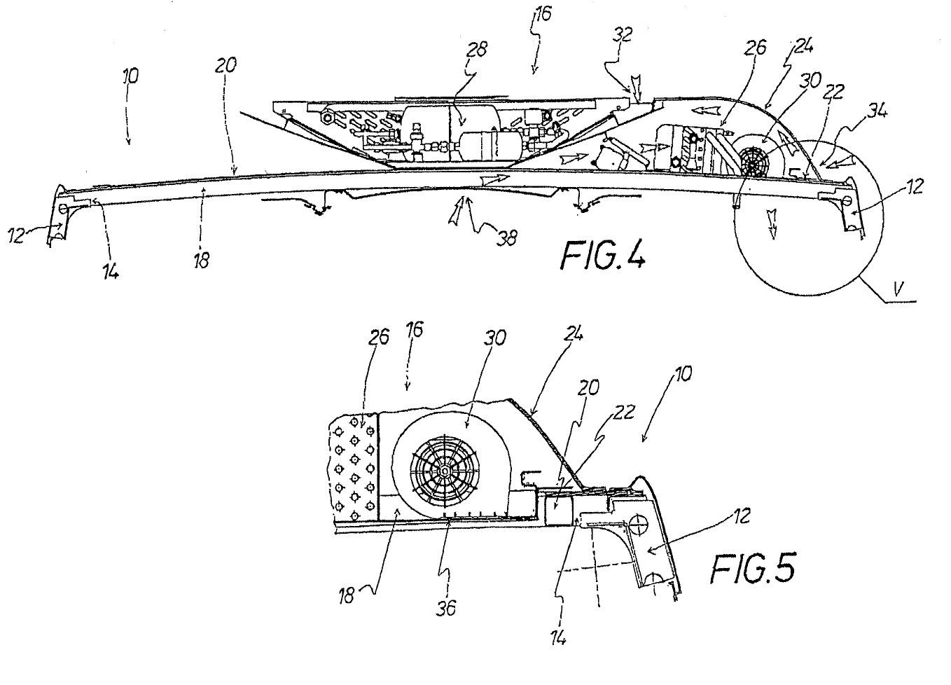

Surface section 10 of the vehicle roof is configured with a roof opening 14 that is designed to receive an air-conditioning system 16 (see FIG. 3). Partial framework 18 that corresponds to roof opening 14 of the vehicle roof—as can be seen in FIG. 4—forms a basic element 20 of air-conditioning system 16, to which components of air-conditioning system 16 are attached.

It can be clearly seen, in particular in FIG. 5, that base element 20 formed by partial framework 18 features a sealing flange 22 that surrounds base element 20. In addition, FIGS. 3, 4, and 5 make it clear that base element 20 formed by partial framework 18 is connected to a covering hood 24 (of which sections are shown). Covering hood 24 covers the corresponding components of air-conditioning system 16, specifically evaporator 26, condenser 28 and blowers 30, as well as pertinent armatures, hose lines, etc.

FIG. 4 make it clear that covering hoods 24 features fresh air inlet openings 32 at its topside and/or fresh air inlet openings 34 at its two opposing lateral side surfaces.

Condenser 28 is positioned in a center part of the air-conditioning system, as can be seen in FIG. 4. Of course, it can also be positioned in front of or behind evaporate 26—viewed in the travel direction. Evaporator 26 is positioned on a bottom tray 36, which—as can be seen in FIG. 5—is recessed into base element 20 of air-conditioning system 16 formed by partial framework 18, for the purpose of reducing the overall height of air-conditioning system 16 over the vehicle roof.

FIG. 4 makes it clear that base element 20 of air-conditioning system 16 formed by partial framework 18 features a bottom return air suction intake 38.

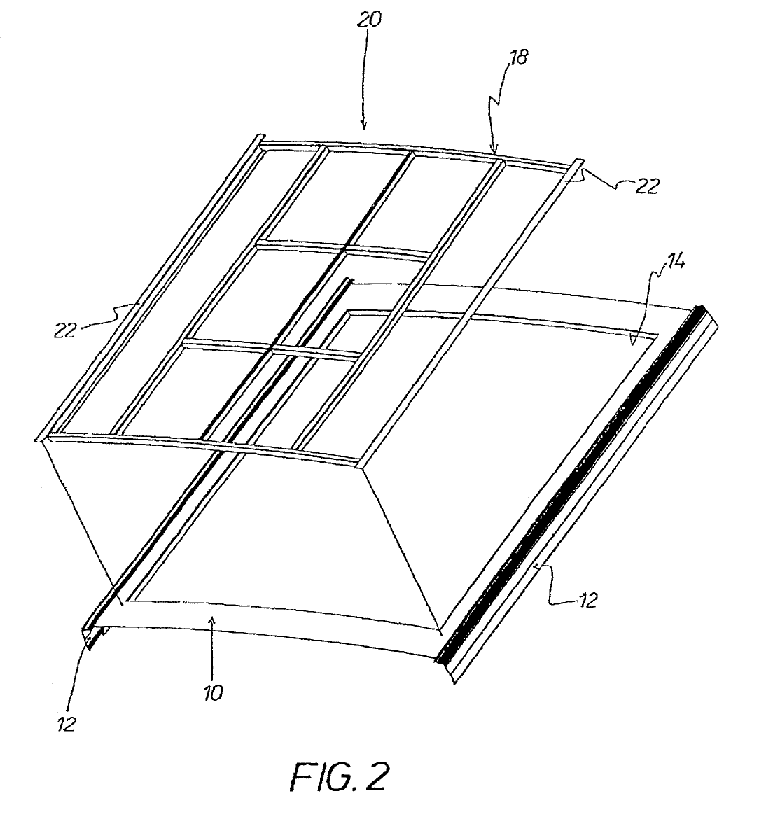

Identical details are designed by identical reference numbers in FIGS. 1-5.

List of reference numbers

10 Surface section

12 Longitudinal profile devices

14 Roof opening (in 10)

16 Air-conditioning system

18 Partial framework (for 16)

20 Base element (of 16)

22 Sealing flange (on 20)

24 Covering hood (of 16)

26 Evaporator (of 16)

28 Condenser (of 16)

30 Blower (of 16)

32 Topsided fresh air inlet openings (on 24)

34 Lateral fresh air inlet openings (on 24)

36 Bottom tray (for 26)

38 return air suction intake (of 16)

1. Air-conditioning system for installation in an opening (14) of a reinforced roof of a vehicle, characterized in that a partial framework (18) corresponding to roof opening (14) forms a base element (20) of an air-conditioning system (16), to which components (26, 28, 30) of air-conditioning system (16) are attached.

2. Air-conditioning system according to claim 1 characterized in that said base element (20) featuring said partial framework (18) features a circumferential sealing flange (22).

3. Air-conditioning system according to claim 1 characterized in that said base element (20) featuring said partial framework (18) is connected to a covering hood (24) covering corresponding components (26, 28, 30) of said air-conditioning system (16).

4. Air-conditioning system according to claim 3 characterized in that said covering hood (24) features, at its topside and/or at its two opposing lateral longitudinal surfaces, fresh air inlet openings (32, 34).

5. Air-conditioning system according to any one of the claims 1-4 characterized in that a condenser (28) is positioned in a central area of said air-conditioning system (16).

6. Air-conditioning system according to any one of claims 1-4 characterized in that a condenser (28) is positioned in a central area of said air-conditioning system and an evaporator (26) is positioned on a bottom tray (36).

7. Air-conditioning system of claim 1 characterized in that a condenser (28) is positioned in a central area of said air-conditioning system (16), an evaporator (26) is positioned on a bottom tray (36) which is recessed into said base element featuring said partial framework.

8. The air-conditioning system according to claim 7 wherein said base element (20) featuring said partial framework (18) also features a bottom return air suction intake opening (38).

9. An air-conditioning system for installation in an opening of a reinforced roof of a vehicle comprising:
a partial framework corresponding to said roof opening forms a base element of said air conditioning system,
said air-conditioning system comprises components which are attached to said partial framework.

10. The air-conditioning system of claim 9 comprising a sealing flanged coupled to said partial framework.

11. The air-conditioning system of claim 1, comprising:
a covering hood covering said components,
said partial framework forming said base element is connected to said covering hood.

12. The air-conditioning system of claim 11, wherein said covering hood comprises a top side and lateral longitudinal surfaces, and fresh air inlet openings located at said topside and at said lateral longitudinal surfaces.
